(19) United States
(12) Patent Application Publication
(10) Pub. No.: US 2005/0007538 A1
(43) Pub. Date: Jan. 13, 2005

(54) Liquid crystal display apparatus

(76) Inventors: Seung-Chang Woo, Cheonan-si (KR); Jeong-Uk Heo, Yongin-si (KR)

Correspondence Address: CANTOR COLBURN LLP, 55 Griffin Road South, Bloomfield, CT, 06002, US

(21) Appl. No.: 10/843,722

(22) Filed: May 12, 2004

(30) Foreign Application Priority Data
Jul. 7, 2003 (KR) 2003-45781

(51) Int. Cl. G02F 1/1339

(52) U.S. Cl. 349/153

(57) ABSTRACT

In an LCD apparatus capable of preventing the separation of a plurality of thin films from each other and improving image display quality, the LCD apparatus includes a plurality of layers such as a glass substrate, an organic layer disposed on the glass substrate, an inorganic transparent electrode formed on the organic layer and a sealant having an organic material. The transparent electrode corresponding to the sealant is patterned so that the organic layer makes contact with the sealant, directly, thereby preventing the leakage of the liquid crystal. Therefore, the image display quality of the LCD apparatus is improved.

### CROSS-REFERENCE OF RELATED APPLICATIONS

The present application claims priority from Korean Patent Application No. 2003-45781, filed on Jul. 7, 2003, the disclosure of which is hereby incorporated herein by reference in its entirety.

### BACKGROUND OF THE INVENTION

1. Field of the Invention

The present invention relates to a liquid crystal display (LCD) apparatus. More particularly, the present invention relates to an LCD apparatus capable of preventing separation of a plurality of thin films from each other and deterioration of image display quality.

2. Description of the Related Art

A liquid crystal, generally, varies arrangement in response to an electric field applied thereto, and thus a light transmittance thereof may be changed.

An LCD apparatus displays information of an electrical signal as an image using electrical and optical characteristics of the liquid crystal. The LCD apparatus is widely applied to various information-processing devices, for example, such as a watch, a cellular phone, a monitor, a notebook or a computer, a television receiver set, an aerospace technology and so on.

A conventional LCD apparatus includes a liquid crystal controlling part and a light supplying part.

The liquid crystal controlling part includes a first substrate that receives a first driving voltage so as to form an electric field controlling an arrangement of the liquid crystal, a second substrate that receives a second driving voltage and a liquid crystal disposed between the first and second substrates. The liquid crystal changes the light transmittance thereof by a voltage difference between the first and second driving voltages.

The first substrate has a first transparent electrode and a switching element. A first transparent conductive inorganic material, for example, such as indium tin oxide (ITO) or indium zinc oxide (IZO) is formed on the first substrate and patterned to form the first transparent electrode to which the first driving voltage is applied. The switching element having a thin film shape applies the first driving voltage to the first transparent electrode.

The second substrate corresponding to the first substrate includes a light blocking pattern, an organic layer and a second transparent electrode. In order to prevent the leakage of a light, an inorganic layer having an inorganic material, for example, such as chrome, chrome oxide, etc., is patterned to form the light blocking pattern. The organic layer is formed over the light blocking pattern. An inorganic layer having an inorganic material, for example, such as indium tin oxide (ITO) or indium zinc oxide (IZO), is formed on the organic layer. The inorganic layer is patterned to form the second transparent electrode.

A sealant having an organic material is disposed between the first and second substrates so as to seal the first and second substrates. The sealant makes contact with the second transparent electrode directly.

When a hot press process is performed so as to combine the first substrate to the second substrate and to maintain cell gap between the first and second substrates, adhesive strength between the sealant and the second transparent electrode is weak. Therefore, the sealant or the organic layer may be separated from the second transparent electrode due to a heat stress so that the liquid crystal may be leaked and the image display quality may be deteriorated.

### BRIEF SUMMARY OF THE INVENTION

The present invention provides an LCD apparatus capable of preventing the separation of a plurality of thin films from each other and deterioration of image display quality.

The LCD apparatus according to an aspect of the present invention includes a first substrate, a second substrate, a sealant and a liquid crystal layer. The first substrate includes a first insulating plate having a first display region and a first peripheral region, and a first electrode disposed in the first display region so as to receive a first driving voltage. The second substrate includes a second insulating plate having a second display region corresponding to the first display region and a second peripheral region corresponding to the first peripheral region, an organic layer formed over the second insulating plate, and a second electrode disposed in the second display region. The sealant that makes a contact with the organic layer is disposed in the first and second peripheral regions. The liquid crystal layer is disposed between the first and second display regions.

The LCD apparatus according to another aspect of the present invention includes a first substrate, a second substrate, a sealant and a liquid crystal layer. The first substrate includes a first insulating plate having a first display region and a first peripheral region, and a first electrode disposed in the first display region so as to receive a first driving voltage. The second substrate includes a second insulating plate having a second display region corresponding to the first display region and a second peripheral region corresponding to the first peripheral region, an organic layer formed over the second insulating plate, and a second electrode disposed in the second display region and a portion of the second peripheral region disposed adjacent to the second display region. The sealant that makes a contact with the organic layer and a portion of the second electrode is disposed in the first and second peripheral regions. The liquid crystal layer is disposed between the first and second display regions.

The LCD apparatus according to still another aspect of the present invention includes a first substrate, a second substrate, a sealant, a connecting part and a liquid crystal layer. The first substrate includes a first insulating plate and a first electrode. The first insulating plate has a first display region and a first peripheral region. The first electrode is disposed in the first display region. A first driving voltage is applied to the first electrode. The second substrate includes a second insulating plate, an organic layer, a second electrode and a power supplying part. The second insulating plate has a second display region corresponding to the first display region and a second peripheral region corresponding to the first peripheral region. The organic layer is formed over the second insulating plate. The second electrode is disposed in the second display region. The power supplying part is electrically connected to the second electrode. The power supplying part is partially protruded from the second electrode toward the second peripheral region. The sealant surrounds the first display region and the second display region. A portion of the sealant makes contact with the power supplying part, and a remaining portion of the sealant makes contact with the organic layer. The connecting part applies a second driving voltage provided from the first peripheral region to the power supplying part protruded outside the sealant. The liquid crystal layer is disposed between the first and second display regions. The first electrode includes a pixel electrode, and the second electrode includes a common electrode.

Therefore, an inorganic layer of a multi-layered structure is patterned to increase adhesive strength between layers of the multi-layered structure so as to prevent the separation of the layers of the multi-layered structure from each other.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view showing an LCD apparatus according to an exemplary embodiment of the present invention;

FIG. 2 is a cross-sectional view taken along the A-A′ line shown in FIG. 1;

FIG. 3 is a plan view showing a first substrate of the LCD apparatus shown in FIG. 1;

FIG. 4 is an enlarged view of part ‘B’ shown in FIG. 3;

FIG. 5 is an enlarged view of part ‘C’ shown in FIG. 3;

FIG. 6 is a cross-sectional view taken along the D-D′ line shown in FIG. 3;

FIG. 7 is a plan view showing a second substrate of the LCD apparatus shown in FIG. 1;

FIG. 8 is a cross-sectional view taken along the E-E′ line shown in FIG. 7;

FIG. 9 is a cross-sectional view showing an LCD apparatus according to another exemplary embodiment of the present invention;

FIG. 10 is a plan view showing a portion of the second substrate shown in FIG. 9;

FIG. 11 is a cross-sectional view showing an LCD apparatus according to another exemplary embodiment of the present invention;

FIG. 12 is a cross-sectional view showing an overlapped side of a color filter formed on a second substrate shown in FIG. 11;

FIG. 13 is a cross-sectional view showing a light blocking layer formed on a second insulating plate shown in FIG. 11;

FIG. 14 is a cross-sectional view showing an LCD apparatus according to another exemplary embodiment of the present invention;

FIG. 15 is a cross-sectional view showing an LCD apparatus according to another exemplary embodiment of the present invention;

FIG. 16 is a cross-sectional view showing an LCD apparatus according to another exemplary embodiment of the present invention; and

FIG. 17 is a cross-sectional view showing an LCD apparatus according to another exemplary embodiment of the present invention.

### DESCRIPTION OF THE PREFERRED EMBODIMENTS

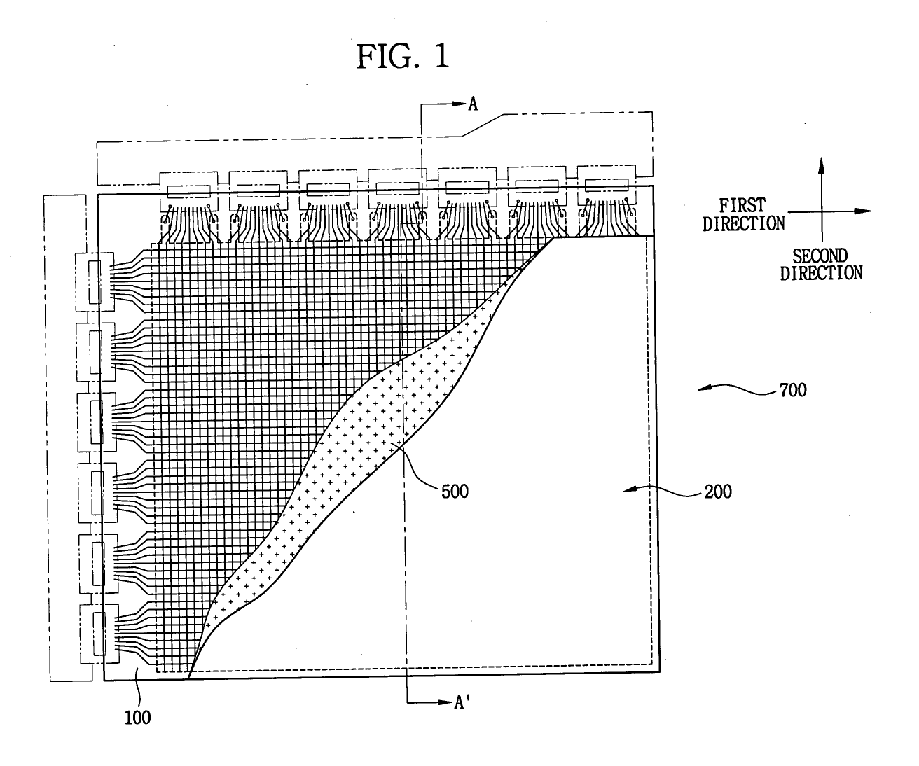

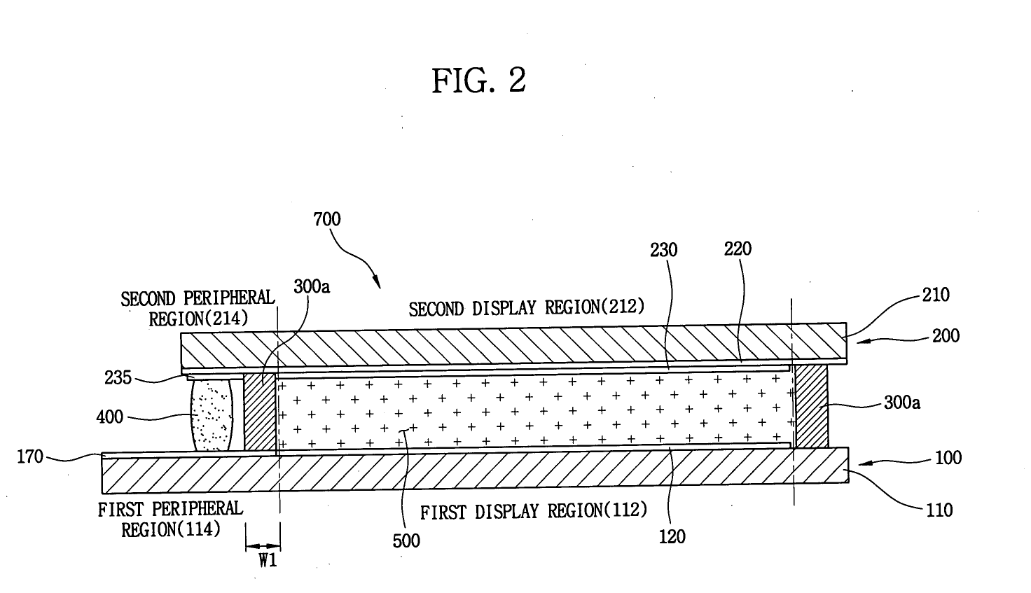

FIG. 1 is a plan view showing a liquid crystal display apparatus according to an exemplary embodiment of the present invention. FIG. 2 is a cross-sectional view taken along the line A-A′ shown in FIG. 1.

Referring to FIGS. 1 and 2, a liquid crystal display (LCD) apparatus 700 includes a first substrate 100, a second substrate 200, a sealant 300a, a connecting part 400 and a liquid crystal layer 500.

The first and second substrates 100 and 200 face each other, and the sealant 300a combines the first substrate 100 with the second substrate 200.

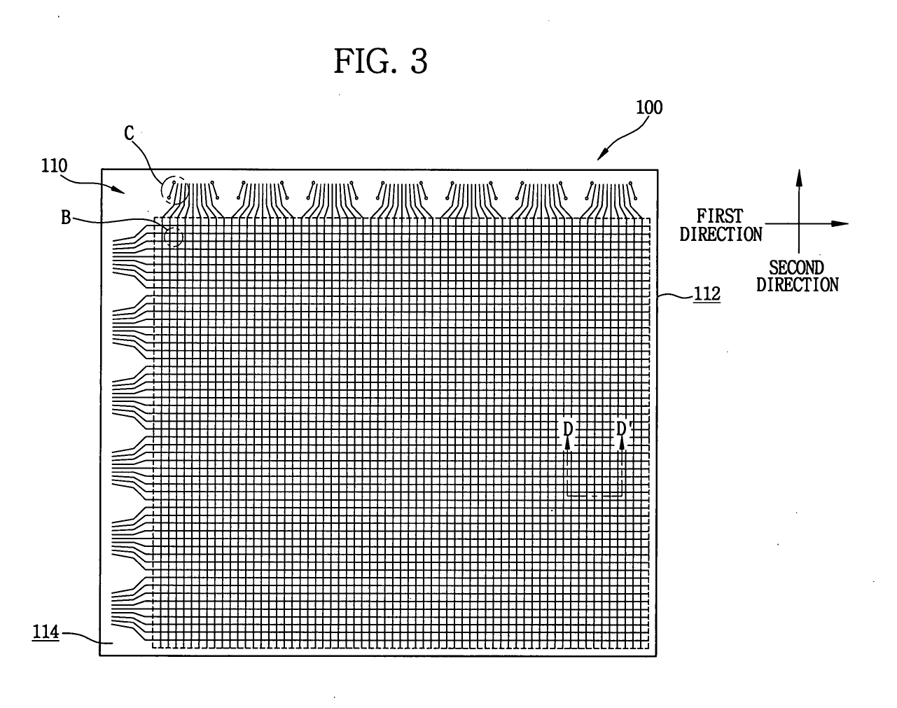

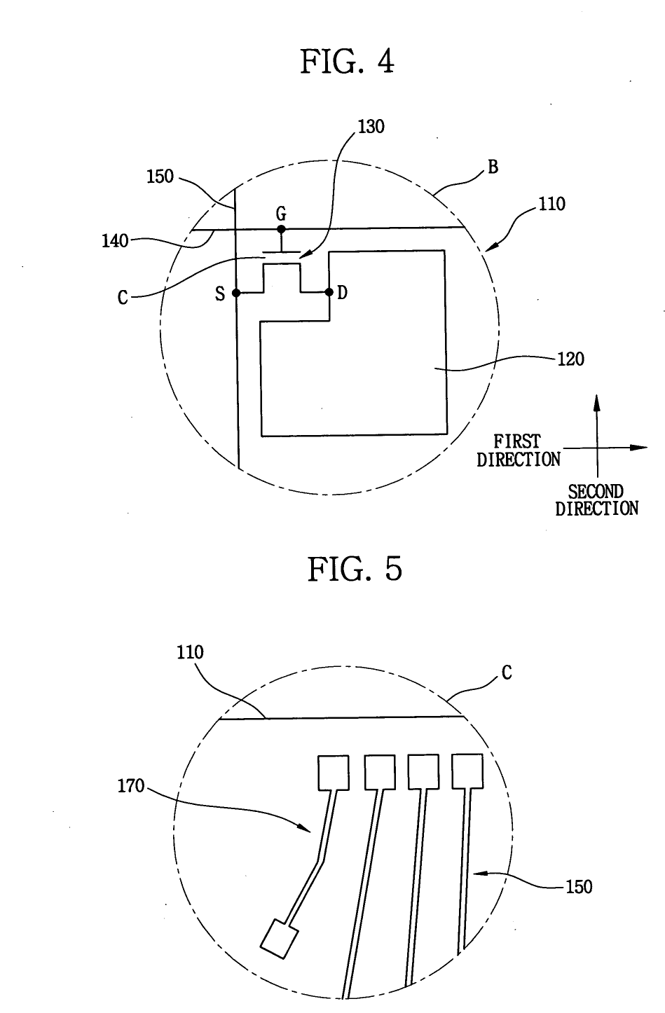

FIG. 3 is a plan view showing a first substrate of the LCD apparatus shown in FIG. 1. FIG. 4 is an enlarged view of part ‘B’ shown in FIG. 3.

Referring to FIGS. 3 and 4, the first substrate 100 includes a first insulating plate 110 and a first electrode 120. The first substrate 100 may include a plurality of the first electrodes 120 arranged in a matrix shape. However, in this exemplary embodiment, since each of the first electrodes 120 has same structure, single first substrate 100 will be described in detail.

The first insulating plate 110 includes a transparent inorganic material having high resistance so as to prevent current flow. In this exemplary embodiment, the first insulating plate 110 includes a glass substrate, a first display region 112 and a first peripheral region 114 surrounding the first display region 112. An image is displayed on the first display region 112, and the image may not be on the first peripheral region 114.

Referring to FIG. 4, each of the first electrodes 120 is disposed in the first display region 112 of the first insulating plate 110. The first electrode 120 has an optical characteristic such as light transmittance and electrical characteristics substantially equal to or better than those of the first insulating plate 110. The first electrode 120 includes an inorganic material, for example, such as indium tin oxide (ITO) or indium zinc oxide (IZO).

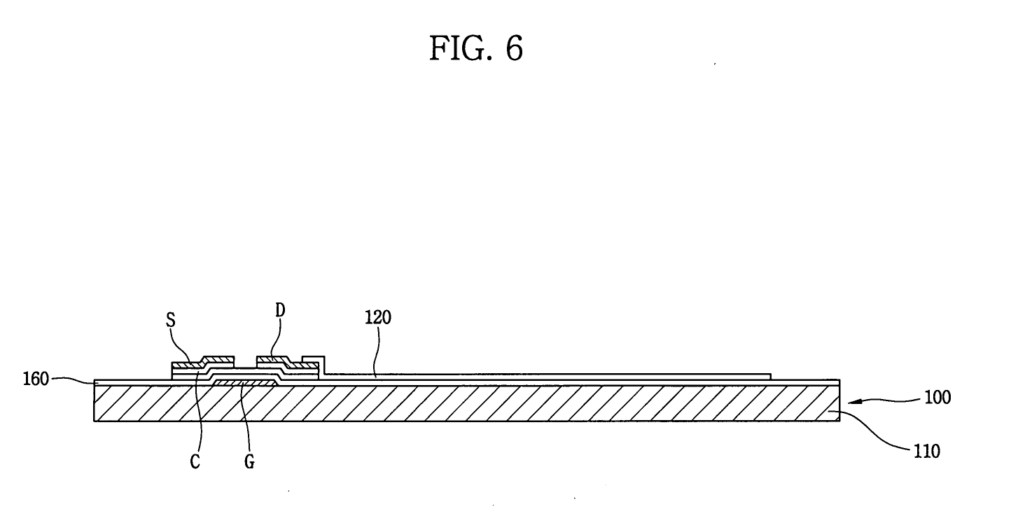

FIG. 5 is an enlarged view of part ‘C’ shown in FIG. 3, and FIG. 6 is a cross-sectional view taken along the line D-D′ shown in FIG. 3.

Referring to FIGS. 3 to 6, a first driving voltage is applied to each of the first electrodes 120. The first driving voltage externally provided to the first substrate 100 is applied to the first electrode 120 disposed in the first display region 112 through the first peripheral region 114.

The first driving voltage is applied to the first electrode 120 through a switching element 130 and a second wire 150. The first substrate 100 may include a plurality of the switching elements 130, the first wires 140 and the second wires 150. However, in this exemplary embodiment, since each of the switching elements 130 has same structure, one switching element 130 will be described in detail.

The switching element 130 is formed corresponding to each of the first electrodes 120. The switching element 130 includes a gate electrode (G), a source electrode (S), a drain electrode (D) and a channel layer (C). A gate insulating layer 160 insulates the gate electrode (G) from the source electrode (S) and the drain electrode (D). The channel later (C) is disposed on the insulating layer 160. The channel layer (C) corresponds to the gate electrode (G). The channel layer (C) includes an amorphous silicon film or a double-layer having an amorphous silicon film and an N⁺ amorphous silicon film formed on the amorphous silicon film. When a voltage having a positive-polarity is applied to the gate electrode (G), the channel layer (C) allows current to be flowed therethrough. The source electrode (S) and the drain electrode (D) spaced apart from the source electrode (S) are formed on the channel layer (C). The drain electrode (D) is connected to the first electrode 120 through a contact hole.

The first wire 140 is connected to the gate electrode (G) of the switching electrode 130. An aluminum (Al) film or an aluminum (Al) alloy film having low resistance is patterned to form the first wire 140. Preferably, the first wire 140 is formed together with the gate electrode (G). The first wire 140 is extended from the first peripheral region 114 into the first display region 112 in a first direction.

Referring to FIG. 3, a number of the first wires 140 depend upon a resolution of the LCD apparatus 700. When the resolution of the LCD apparatus is 1024×768, the number of the first wires 140 in the LCD apparatus 700 is 768 units. The first wires 140 are disposed in the first display region 112, and spaced apart from each other by a first interval. End portions of 256 units of the first wires 140 are disposed in the first peripheral region 114, and spaced apart from each other by a second interval that is narrower than the first interval so as to form first channels. In the first peripheral region 114, the first wires 140 are grouped into three groups. Each of the three groups has the first wires of 256 units. Therefore, the LCD apparatus 700 having the resolution of 1024×768 includes about three first channels, and a gate tape carrier package is combined with each of the first channels.

Referring to FIG. 6, the second wire 150 is connected to the source electrode (S) of the switching element 130. An aluminum (Al) film or an aluminum alloy film having low resistance is patterned to form the second wire 150. Preferably, the second wire 150 is formed with the source electrode (S) and the drain electrode (D). The second wire 150 is extended from the first peripheral region 114 into the first display region 112 in a second direction.

A number of the second wires 150 also depend upon the resolution of the LCD apparatus 700. When the LCD apparatus has the resolution of 1024×768, the LCD apparatus 700 has the second wires 150 of 1024×3 units. The second wires 150 are disposed in the first display region 112, and spaced apart from each other by the third interval. The second wires 150 are disposed in the first peripheral region 114, and spaced apart from each other by a fourth interval that is narrower than the third interval so that second channels may be formed. The second wires 150 are grouped into twelve groups. Each of the twelve groups has the second wires 150 of 256 units. Therefore, the LCD apparatus 700 having the resolution of 1024×768 includes about 12 second channels, and a source tape carrier package is combined with each of the second channels.

The first wires 140 are substantially perpendicular to the second wires 150, and the first and second wires 140 and 150 are insulated from one another so as to prevent an undesired shorting therebetween.

A transmitting pattern 170 is disposed in the first peripheral region 114. A plurality of the transmitting patterns 170 may be disposed in the first peripheral region 114. In this exemplary embodiment, two transmitting patterns are formed in each of the second channels of the second wires 150 disposed in the first peripheral region 114. The transmitting patterns 170 receive a second driving voltage that is externally provided, and provides the second driving voltage to the second peripheral region 114.

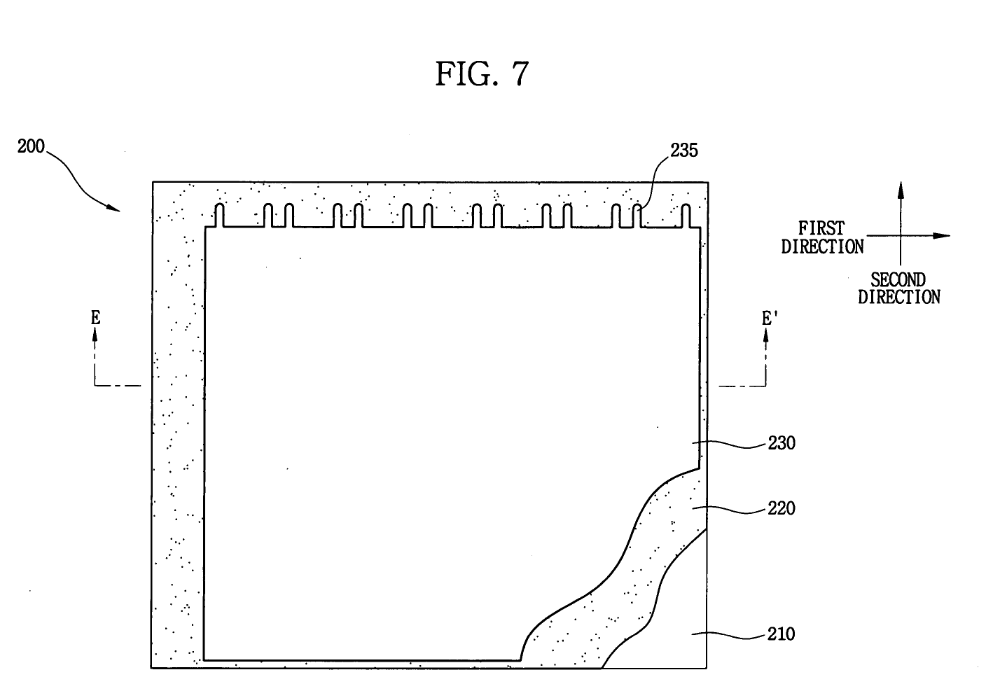

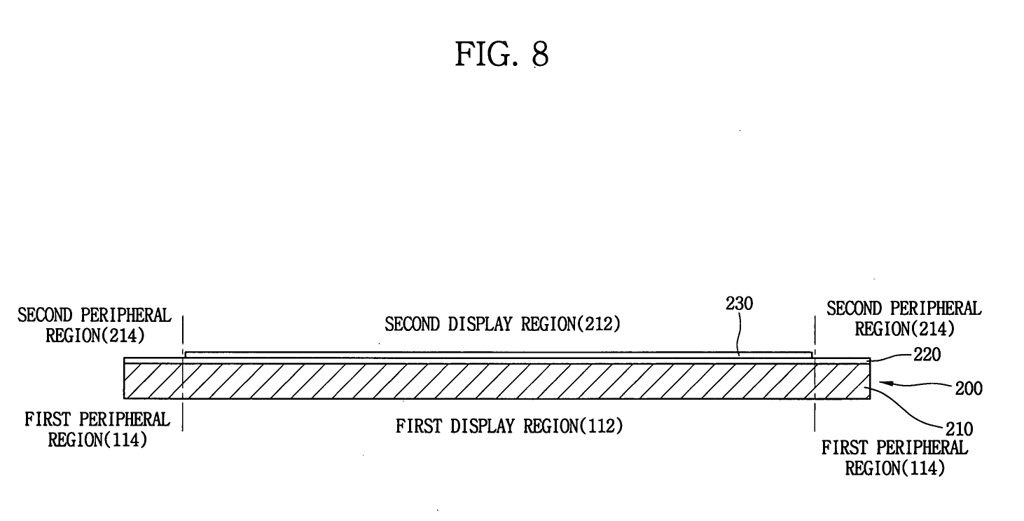

FIG. 7 is a plan view showing a second substrate of the LCD apparatus shown in FIG. 1, and FIG. 8 is a cross-sectional view taken along the line E-E′ shown in FIG. 7.

Referring to FIGS. 1, 7 and 8, the second substrate 200 includes a second insulating plate 210, an organic insulating layer 220, a second electrode 230 and a power supplying part 235. The second substrate 200 may include a plurality of the power supplying parts 235.

The first and second insulating plates 110 and 210 face each other. The second insulating plate 210 includes a transparent inorganic material having high resistance so as to prevent current flow. The second insulating plate 210 includes a glass substrate, and also includes a second display region 212 and a second peripheral region 214 surrounding the second display region 212. An image is displayed on the second display region 212, and the image may not be displayed on the second peripheral region 214. An area of the first display region 112 is substantially equal to that of the second display region 212, and a shape of the first display region 112 is also substantially equal to that of the second display region 212.

An organic layer 220 is formed on the second display region 212 and the second peripheral region 214. That is, the organic layer 220 is formed over the second insulating plate 210. An adhesive strength between the organic layer 220 and the sealant 300a is stronger than an adhesive strength between the sealant 300a and an inorganic material such as the second electrode 230. Therefore, the adhesive strength may be increased by means of combining the sealant 300a with the organic layer 220.

The second electrode 230 is disposed on the organic layer 220, and includes transparent conductive inorganic material, for example, such as indium tin oxide (ITO) or indium zinc oxide (IZO). The second electrode 230 is not formed in the second peripheral region 214 of the second insulating plate 210, but is selectively formed in the second display region 212. In order to form the second electrode 230 in the second display region 212, the transparent conductive inorganic material is firstly formed on the second insulating plate 210. The transparent conductive inorganic material formed on the second insulating plate 210 is then patterned to form the second electrode 230. The adhesive strength between the organic layer 220 and the sealant 300a is stronger than the adhesive strength between the sealant 300a and the inorganic material such as the second electrode 230. Therefore, the adhesive strength may be increased by means of combining the sealant 300a with the organic layer 220.

The power supplying parts 235 are protruded from a side of the second electrode 230 disposed in the second display region 212 into the second peripheral region 214. The second substrate 200 includes at least two power supplying parts 235 that are protruded from the side of the second electrode 230 to the second peripheral region 214. Each of the power supplying parts 235 is protruded to the side of the second electrode 230 so as to face each of the transmitting patterns. Preferably, a length of each of the power supplying parts 235 is longer than a width (W) of the sealant 300a.

Referring to FIG. 2, the sealant 300a is disposed between the first and second insulating plates 110 and 210 so that the first insulating plate 110 is combined with the second insulating plate 210. The sealant 300a includes an organic bonding material having high fluidity. The sealant having a band shape is disposed on a position adjacent to the sides of the first display region 112 or the second display region 212. When a portion of the sealant 300a is leaked into the first display region 112 or the second display region 212, the image display quality may be deteriorated. Therefore, the amount of the sealant 300a is controlled so as to prevent the leakage of the sealant 300a.

The sealant 300a disposed in the first peripheral region 114 and the second peripheral region 214 surrounds the first display region 112 and the second display region 212 to form a space between the first and second display regions 114 and 214. The liquid crystal layer 500 is disposed in the space between the first and second display regions 114 and 214. A portion of the sealant 300a makes contact with the organic layer 220 disposed in the second peripheral region 214, directly. A remaining portion of the sealant 300a makes contact with the power supplying parts 235 protruded from the second display region 212 to the second peripheral region 214. The sealant 300a having an organic material makes contact with the organic layer 220, directly to increase the adhesive strength between the sealant 300a and the second substrate 200, thereby preventing the leakage of the liquid crystal of the liquid crystal layer 500.

Referring to FIG. 2, the connecting part 400 electrically connects each of the power supplying parts 235 with each of the transmitting patterns 170. The power supplying part 235 is disposed in the second peripheral region 214, and the transmitting pattern 170 is disposed in the first peripheral region 114. The second peripheral region 214 is partially covered by the sealant 300a. The transmitting pattern 170 is disposed in the first peripheral region 114. A conducting paste, which is a mixture of a gold (Au) powder or a powder of a conductive material, is disposed between the power supplying part 235 and the transmitting pattern 170 to form the connecting part 400. The second driving voltage is applied from the transmitting pattern 170 to the second electrode 230 through the connecting part 400 and the power supplying part 235.

The liquid crystal layer 500 is disposed in the space formed by the first display region 112, the second display region 212 and the sealant 300a.

In order to combine the sealant 300a having an organic material with the organic layer 220, the second electrode 230 corresponding to the organic layer 220 is partially removed so as to improve the adhesive strength between the sealant 300a and the second insulating plate 210, thereby preventing the leakage of the liquid crystal of the liquid crystal layer 500 and the inflow of an air into the space.

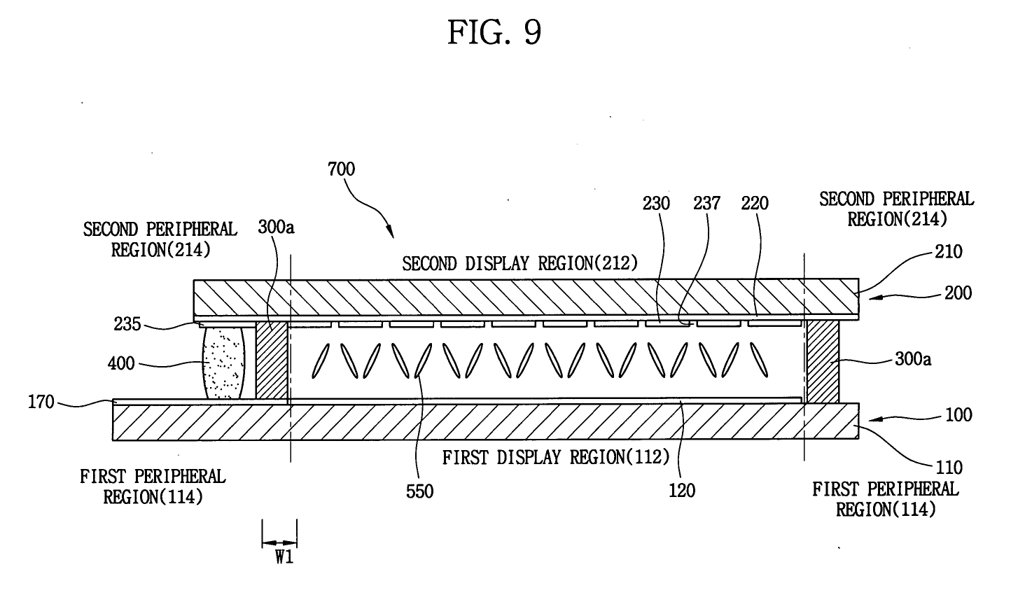

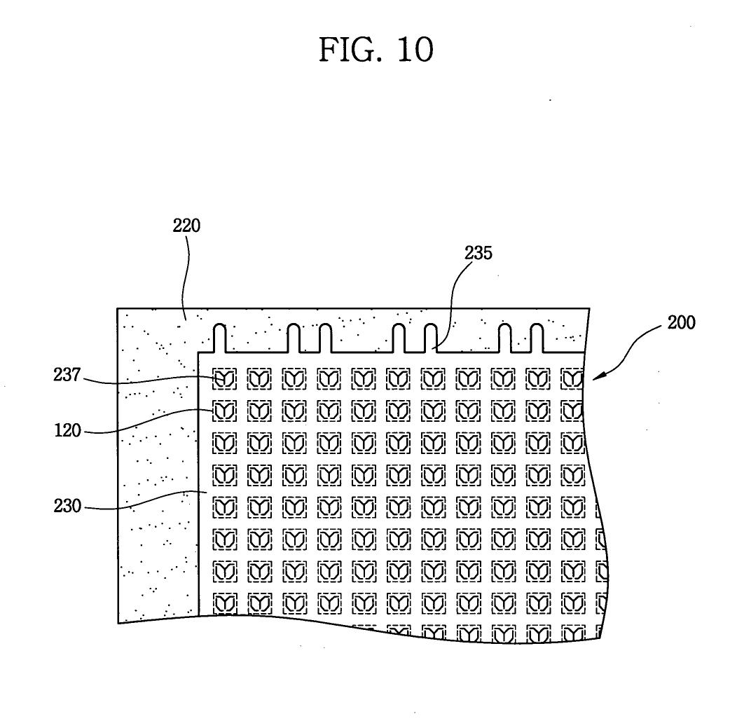

FIG. 9 is a cross-sectional view showing an LCD apparatus according to another exemplary embodiment of the present invention, FIG. 10 is a plan view showing a portion of the second substrate shown in FIG. 9.

The LCD apparatus in FIGS. 9 and 10 is same as in FIGS. 1 to 8 except for a second electrode and a liquid crystal layer. Thus, the same reference numerals will be used to refer to the same or like parts as those described in FIGS. 1 to 8 and any further explanation will be omitted.

Referring to FIGS. 9 and 10, a liquid crystal alignment part 237 is formed in a second electrode 230 at a position corresponding to first electrodes 120. A plurality of the liquid crystal alignment part 237 may be formed in the second electrode 230. The first electrodes 120 and the second electrode 230 are partially patterned in a slit shape to form grooves that are the liquid crystal alignment parts 237.

A liquid crystal layer 550 has a vertical alignment mode liquid crystal. When a first driving voltage and a second driving voltage are not applied to the first and second electrodes 120 and 230, respectively, the liquid crystal of the liquid crystal layer 550 is aligned substantially perpendicular to the first and second electrodes 120 and 230. When the first driving voltage and the second driving voltage are applied to the first and second electrodes 120 and 230, respectively, the liquid crystal of the liquid crystal layer 550 is inclined toward the first and second electrodes 1.20 and 230. When the liquid crystal layer 550 has portions aligned in different directions from each other, the viewing angle and contrast ratio of an image may be increased.

According to the present exemplary embodiment, the liquid crystal layer 550 has the vertical alignment mode liquid crystal, and the liquid crystal alignment parts 237 are formed in the first electrodes 120 formed on the first insulating plate 110 and the second electrode 230 formed on the second insulating plate 210 so as to increase the viewing angle and the contrast ratio, thereby improving image display quality.

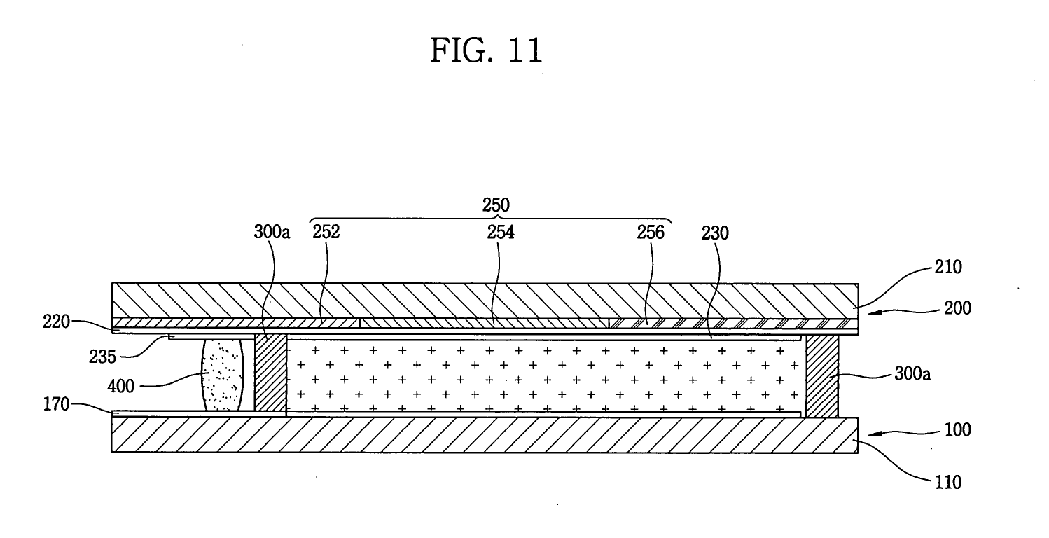

FIG. 11 is a cross-sectional view showing an LCD apparatus according to another exemplary embodiment of the present invention.

The LCD apparatus shown in FIG. 11 is same as in FIGS. 1 to 8 except for a color filter. Thus, the same reference numerals will be used to refer to the same or like parts as those described in FIGS. 1 to 8 and any further explanation will be omitted.

Referring to FIG. 11, color filters 250 are formed between a second insulating plate 210 and an organic layer 220. The color filters 250 filter a light passing through first electrodes 120 and a liquid crystal layer 500 corresponding to the first electrodes 120 so as to generate primary lights including a red light, a green light and a blue light. The color filters 250 include a red color filter 252, a green color filter 1o 254 and a blue color filter 256. The red light, the green light and the blue light pass through the red color filter 252, the green color filter 254 and the blue color filter 256, respectively.

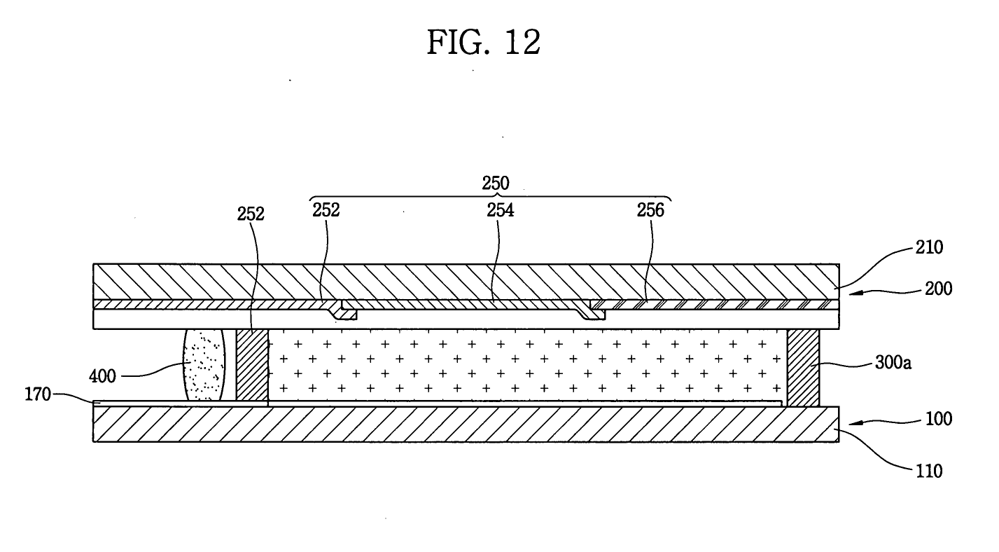

FIG. 12 is a cross-sectional view showing an overlapped side of a color filter formed on a second substrate shown in FIG. 11.

Referring to FIG. 12, sides of the color filters 250 formed between the second insulating plate 210 and an organic layer 220 are overlapped with each other. For example, a side of the red color filter 252 may be overlapped with a side of the green color filter, a side of the green color filter 254 may be overlapped with a side of the blue color filter, and a side of the blue color filter 256 may be overlapped with a side of the red color filter 252.

When the sides of the red, green and blue color filters 252, 254 and 256 are overlapped with each other, light transmittance is decreased in the overlapped portion by a subtractive color mixture. Therefore, a light passing through a space between the first electrodes 120 is blocked by the overlapped portion of the color filters 250, thereby improving image display quality.

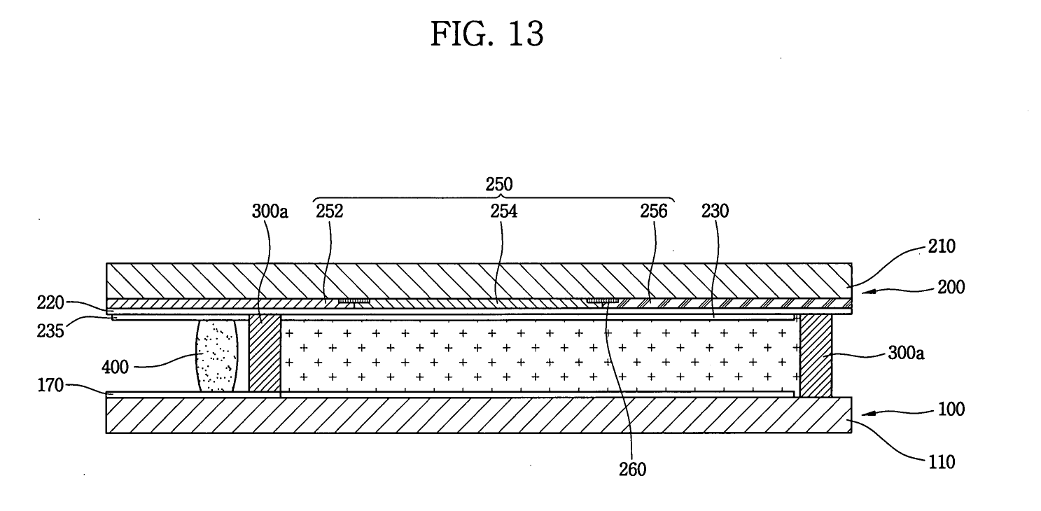

FIG. 13 is a cross-sectional view showing a light blocking layer formed on a second insulating plate shown in FIG. 11.

Referring to FIG. 13, a light blocking layer 260 is formed between the second insulating plate 210 and the color filter 250. The light blocking layer 260 blocks the light passing through the space between the first electrodes 120, thereby improving the image display quality. A portion of the light blocking layer 260 corresponding to the first electrodes 120 is exposed, and the light blocking layer 260 has a lattice shape so as to block the space between the first electrodes 120. The light blocking layer 260 includes a black organic layer, a chrome (Cr) film, a chrome oxide film or chrome.

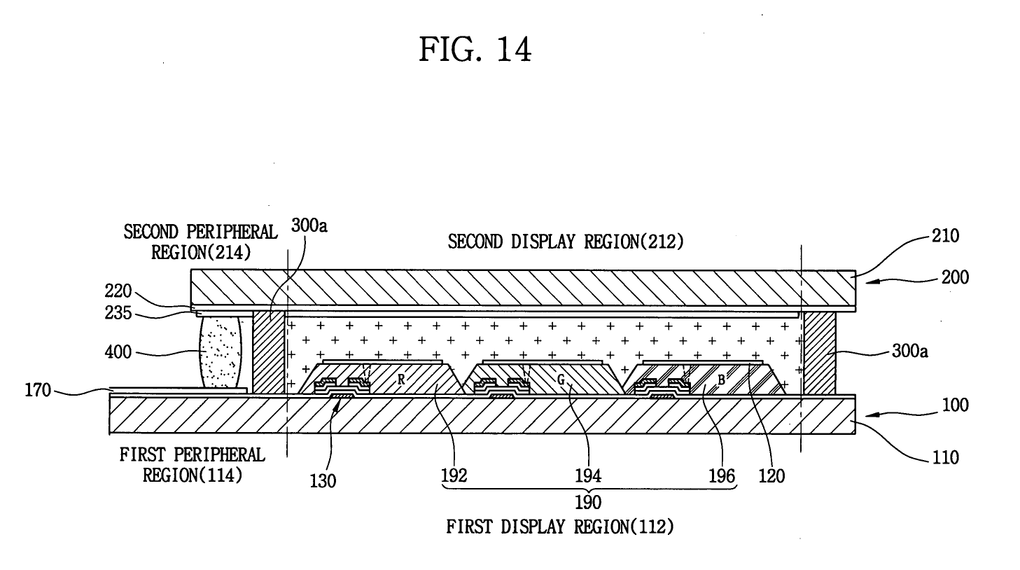

FIG. 14 is a cross-sectional view showing an LCD apparatus according to another exemplary embodiment of the present invention.

The LCD apparatus in FIG. 14 is same as in FIGS. 1 to 8 except for a color filter. Thus, the same reference numerals will be used to refer to the same or like parts as those described in FIGS. 1 to 8 and any further explanation will be omitted.

Referring to FIG. 14, a color filter 190 is formed on a first insulating plate 110. A plurality of the color filters 190 may be formed on a first insulating plate 110. The color filters 190 include a red color filter 192, a green color filter 194 and a blue color filter 196. Each of the color filters 192,194 and 196 covers a switching element 130, a first wire 140 and a second wire 150, and corresponds to each of first electrodes 120.

An interval between each of the first electrodes 120 and the switching element 130, an interval between the first electrode 120 and the first wire 140, and an interval between the first electrode 120 and the second wire 150 are adjusted by means of the red, green and blue color filters 192, 194 and 196. Therefore, a parasite capacitance formed between the first electrode 120 and the switching element 130, a parasite capacitance formed between the first electrode 120 and the first wire 140, and a parasite capacitance formed between the first electrode 120 and the second wire 150 are decreased. In addition, the areas of the first electrodes 120 are increased by means of the red, green and blue color filters 192,194 and 196 so as to increase the opening rate and brightness of the LCD apparatus.

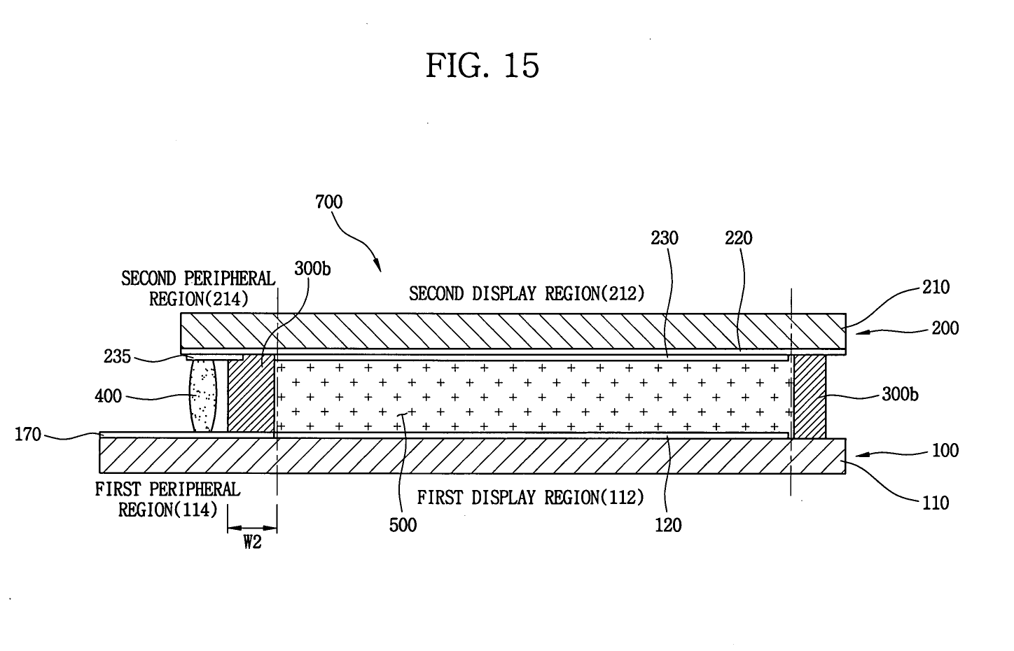

FIG. 15 is a cross-sectional view showing an LCD apparatus according to another exemplary embodiment of the present invention. The LCD apparatus in FIG. 15 is same as in FIGS. 1 to 8 except for a sealant. Thus, the same reference numerals will be used to refer to the same or like parts as those described in FIGS. 1 to 8 and any further explanation will be omitted.

Referring to FIG. 15, the sealant 300b is disposed between a first insulating plate 110 and a second insulating plate 120 to combine the first insulating plate 110 to the second insulating plate 120. The sealant 300b having a band shape is disposed on adjacent to sides of a first display region 112 or a second display region 212. A portion of the sealant 300b makes contact with an organic layer 220 that is disposed in a second peripheral region 214. Remaining portion of the sealant 300b makes contact with a plurality of power supplying parts 235 that are protruded from the second display region 212 to the second peripheral region 214. Preferably, a length of each of the power supplying parts 235 is longer than a width (W2) of the sealant 300b.

The sealant 300b having an organic material makes contact with the organic layer 220 and the power supplying part 235, directly, to increase the adhesive strength between the sealant 300b and the second substrate 200. In addition, the width (W2) of the sealant 300b is increased to prevent the leakage of a liquid crystal of a liquid crystal layer 500.

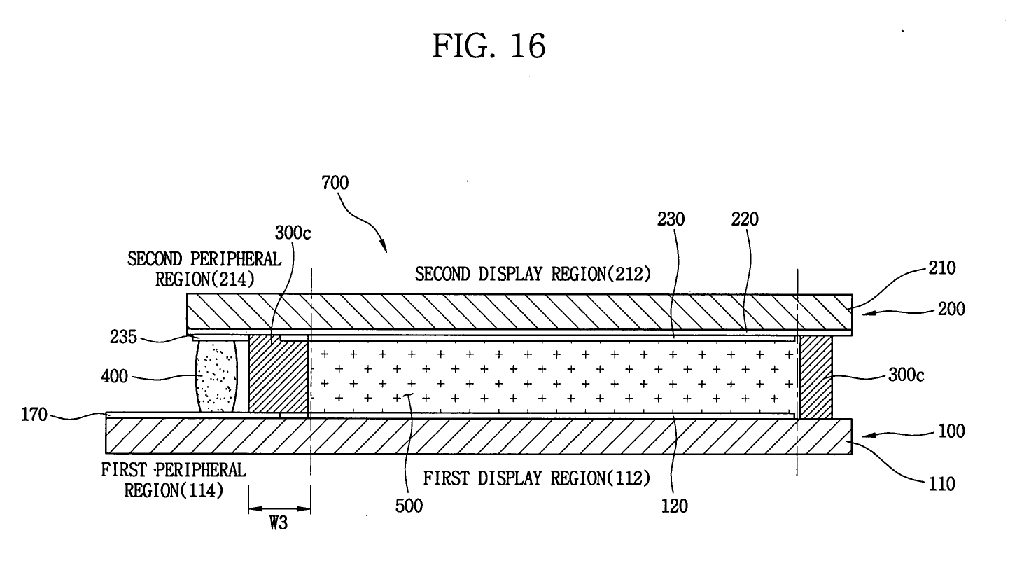

FIG. 16 is a cross-sectional view showing an LCD apparatus according to another exemplary embodiment of the present invention. The LCD apparatus in FIG. 16 is same as in FIGS. 1 to 8 except for a sealant. Thus, the same reference numerals will be used to refer to the same or like parts as those described in FIGS. 1 to 8 and any further explanation will be omitted.

Referring to FIG. 16, the sealant 300c is disposed between a first insulating plate 110 and a second insulating plate 120 to combine the first insulating plate 110 to the second insulating plate 120. The sealant 300c having a band shape is disposed on adjacent to sides of a first display region 112 or a second display region 212. About a half of the sealant 300c makes contact with an organic layer 220 that is disposed in a second peripheral region 214. Remaining portion of the sealant 300c makes contact with a portion of a second electrode 230, which is disposed on the second peripheral region 214. The second electrode 230 is disposed in the second display region 212 and a portion of the second peripheral region 214, which is disposed adjacent to the second display region 212. Preferably, a length of each of power supplying parts 235 is longer than a width (W3) of the sealant 300c.

The sealant 300c having an organic material makes contact with the organic layer 220 and the portion of the second electrode 230, directly, to increase the adhesive strength between the sealant 300c and the second substrate 200. In addition, the width (W3) of the sealant 300c is increased to prevent the leakage of a liquid crystal of a liquid crystal layer 500.

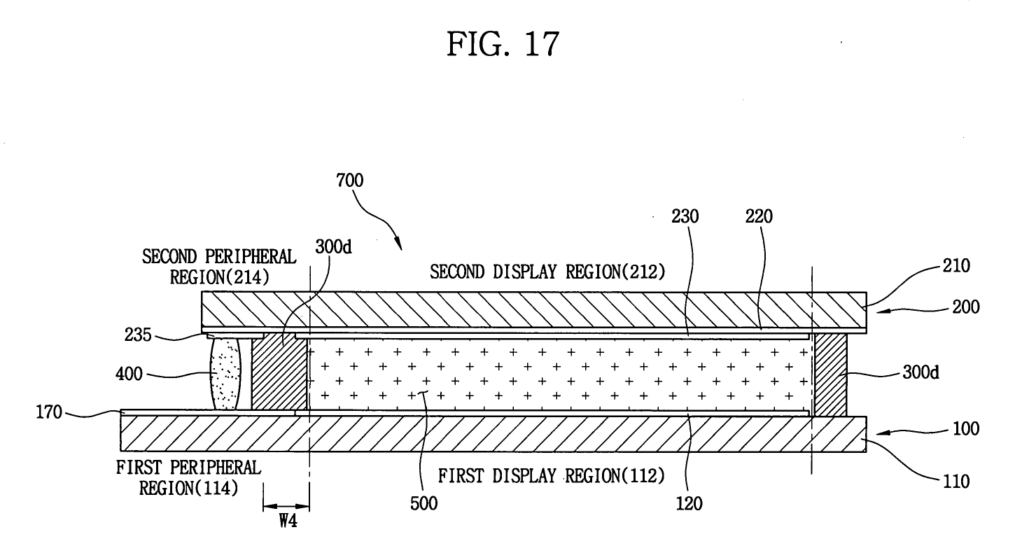

FIG. 17 is a cross-sectional view showing an LCD apparatus according to another exemplary embodiment of the present invention. The LCD apparatus in FIG. 17 is same as in FIGS. 1 to 8 except for a sealant. Thus, the same reference numerals will be used to refer to the same or like parts as those described in FIGS. 1 to 8 and any further explanation will be omitted.

Referring to FIG. 17, the sealant 300d is disposed between a first insulating plate 110 and a second insulating plate 120 to combine the first insulating plate 110 to the second insulating plate 120. The sealant 300d having a band shape is disposed on adjacent to sides of a first display region 112 or a second display region 212. A portion of the sealant 300d makes contact with an organic layer 220 that is disposed in a second peripheral region 214. Remaining portions of the sealant 300d make contact with portions of power supplying parts 235 that are protruded from the second display region 212 to the second peripheral region 214 and a portion of a second electrode 230, which is disposed on the second peripheral region 214. The second electrode 230 is disposed in the second display region 212 and a portion of the second peripheral region 214, which is disposed adjacent to the second display region 212. Preferably, a length of each of the power supplying parts 235 is longer than a width (W4) of the sealant 300d.

The sealant 300d having an organic material makes contact with the organic layer 220, the portions of the power supplying parts 235 and the portion of the second electrode 230, directly, to increase the adhesive strength between the sealant 300d and the second substrate 200. In addition, the width (W3) of the sealant 300c is increased to prevent the leakage of a liquid crystal of a liquid crystal layer 500.

As mentioned above, a transparent electrode is patterned so that organic layers of an LCD panel make contact with a sealant, directly thereby preventing separation of the layers and the leakage of liquid crystal so as to improve the image display quality of an LCD apparatus.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A liquid crystal display apparatus comprising:
a first substrate that includes a first insulating plate having a first display region and a first peripheral region, and a first electrode disposed in the first display region so as to receive a first driving voltage;
a second substrate that includes a second insulating plate having a second display region corresponding to the first display region and a second peripheral region corresponding to the first peripheral region, an organic layer formed over the second insulating plate, and a second electrode disposed in the second display region;
a sealant disposed in the first and second peripheral regions and making contact with the organic layer; and
a liquid crystal layer disposed between the first and second display regions.

2. The liquid crystal display apparatus of claim 1, wherein the second substrate further comprises a power supplying part electrically connected to the second electrode, the power supplying part being protruded from the second electrode to the second peripheral region.

3. The liquid crystal display apparatus of claim 2, wherein a portion of the sealant makes contact with the power supplying part.

4. The liquid crystal display apparatus of claim 2, further comprising a connecting part that applies a second driving voltage provided from the first peripheral region to the power supplying part protruded outside the sealant.

5. A liquid crystal display apparatus comprising:
a first substrate that includes a first insulating plate having a first display region and a first peripheral region, and a first electrode disposed in the first display region so as to receive a first driving voltage;
a second substrate that includes a second insulating plate having a second display region corresponding to the first display region and a second peripheral region corresponding to the first peripheral region, an organic layer formed over the lo second insulating plate, and a second electrode disposed in the second display region and a portion of the second peripheral region, which is disposed adjacent to the second display region;
a sealant disposed in the first and second peripheral regions and making contact with the organic layer and a portion of the second electrode; and
a liquid crystal layer disposed between the first and second display regions.

6. The liquid crystal display apparatus of claim 5, wherein about a half of the sealant makes contact with the second electrode.

7. The liquid crystal display apparatus of claim 5, wherein the second substrate further comprises a power supplying part electrically connected to the second electrode, the power supplying part being protruded from the second electrode.

8. The liquid crystal display apparatus of claim 7, wherein the sealant makes contact with the voltage supplying part.

9. A liquid crystal display apparatus comprising:
a first substrate that includes a first insulating plate having a first display region and a first peripheral region, and a first electrode disposed in the first display region so as to receive a first driving voltage;
a second substrate that includes a second insulating plate having a second display region corresponding to the first display region and a second peripheral region corresponding to the first peripheral region, an organic layer formed over the second insulating plate, a second electrode disposed in the second display region, and a power supplying part electrically connected to the second electrode and partially protruded from the second electrode to the second peripheral region;
a sealant that surrounds the first and second display regions, a portion of the sealant making contact with the power supplying part and a remaining portion of the sealant making contact with the organic layer;
a connecting part that applies a second driving voltage provided from the first peripheral region to the power supplying part protruded outside the sealant; and
a liquid crystal layer disposed between the first and second display regions.

10. The liquid crystal display apparatus of claim 9, wherein the second substrate comprises at least two power supplying parts that are electrically connected to the second electrode and protruded from the second electrode.

11. The liquid crystal display apparatus of claim 9, wherein the connecting part comprises a conductive paste having a conductive powder.

12. The liquid crystal display apparatus of claim 9, wherein the first driving voltage is applied to the first electrode by means of a switching element connected to the first electrode, a first wire applying the first driving voltage to the switching element in response to a timing signal, and a second wire where the timing signal is applied to.

13. The liquid crystal display apparatus of claim 9, wherein the second electrode comprises a liquid crystal alignment part having a groove shape.

14. The liquid crystal display apparatus of claim 13, wherein the liquid crystal layer comprises a vertical alignment mode liquid crystal.

15. The liquid crystal display apparatus of claim 9, wherein the first substrate further comprises a plurality of the first electrodes, the second substrate further comprises a plurality of color filters disposed between the organic layer and the second insulating plate, and the color filters are formed at positions corresponding to the first electrodes.

16. The liquid crystal display apparatus of claim 15, wherein the second substrate further comprises a light blocking layer disposed between the color filters and the second insulating plate to block a light passing through a space between the first electrodes.

17. The liquid crystal display apparatus of claim 16, wherein the light blocking layer comprises an opaque organic material, chrome or chrome oxide.

18. The LCD apparatus of claim 15, wherein sides of the color filters are overlapped with each other to block a light passing through a space between the first electrodes.

19. The LCD apparatus of claim 9, wherein the first substrate further comprises a plurality of the first electrodes, and further comprising a plurality of color filters disposed between the first electrodes and the first insulating plate.

20. The LCD apparatus of claim 19, wherein the first electrodes are arranged in a matrix shape, and sides of the color filters are overlapped with each other.
